(19) United States
(12) Patent Application Publication
(10) Pub. No.: US 2016/0003705 A1
(43) Pub. Date: Jan. 7, 2016

(54) ACOUSTIC LINER DAMAGE DETECTOR

(71) Applicant: David Aaron JOHNSON, (US)

(72) Inventor: David Aaron JOHNSON, Burleigh Heads (AU)

(21) Appl. No.: 14/768,860

(22) PCT Filed: Feb. 16, 2014
(86) PCT No.: PCT/AU2014/000131

§ 371 Date: Aug. 19, 2015

(30) Foreign Application Priority Data
Feb. 19, 2013 (AU) 2013900550

(51) Int. Cl. G01M 3/34

(52) U.S. Cl. CPC G01M 3/34

(57) ABSTRACT

A damage detector for an acoustic liner sandwich of an internal cellular structure between a whole skin and a perforated skin comprises a cup shaped body the open end of which maintains sealing engagement with the perforated skin of the liner and a vacuum line connected to the body and a pressure gauge so that a loss of vacuum registered on the gauge indicates damage to the internal structure. The sealing engagement is achieved by locating a flexible annulus in a mating recess in the open end of the cup shaped body where the width of the annulus is between one and two maximum widths of the cells of the internal structure.

### FIELD OF THE INVENTION

This invention relates to non destructive testing for the detection of damage in honey comb perforated skin sandwich structures such as those used in jet engine acoustic liners.

### BACKGROUND OF THE INVENTION

It is difficult to detect damage to the internal structure of sandwich panels since the latter are covered by external skins and the internal structure is not visible. Corrosion of the internal structure can take place without any indication on the external skins. Accordingly regular inspection is presently carried out since a break up of the panel could result in catastrophic engine failure.

The current way of inspecting such panels is to tap the external skins and listen for a variation in the resonant sound. However the only sure test is to remove the external skin and re-bond it to the internal structure after any damage is visually detected and repaired. This is an expensive process and some maintenance regimes find it less costly simply to replace the liners at a cost of approximately $100,000 per engine.

U.S. Pat. No. 2,453,338 teaches an instrument which is able to detect deflection in the external layers of composite sandwich structures. This instrument comprises a cup like member to be placed with its open side against a sheet of laminar material, said cup-like member having a transparent wall opposite said open side, a vacuum line in communication with said member to continuously exhaust the interior of said member and a vacuum control valve mounted in the wall of said member to control the pressure within said member.

A pressure gauge mounted in the member and visible through its transparent wall indicates a variation in the vacuum when the member encounters a bulge in the sheet due to de-lamination. While this instrument can detect irregularities in the external sheet it cannot detect damage to an internal structure such as is used in jet engine acoustic liners when there is no irregularity in the external skin.

### OBJECT OF THE INVENTION

It is therefore an object of the present invention to provide an instrument which can detect damage to an internal structure of a sandwich panel without removing the external skin or at least to provide a useful alternative to existing testing methods.

### STATEMENT OF THE INVENTION

According to the present invention a damage detector for an acoustic liner sandwich of a structure between a whole skin and a perforated skin comprises a cup shaped body the open end of which maintains sealing engagement with the perforated skin of the liner and a vacuum line connected to the body and a pressure gauge so that a loss of vacuum registered on the gauge indicates damage to the internal structure.

Preferably sealing engagement is achieved by locating a flexible annulus in a mating recess in the open end of the cup shaped body.

Preferably the width of the annulus is between one and two maximum widths of the cell.

Preferably the vacuum line and the pressure gauge are connected at opposite sides of a T junction connector mounted on the body.

Preferably the detector of claim 1 is linked to a processor and graphic user interface.

Preferably pressure and XYZ position pickups from the detector feed data to a processor which transmits a graphic record of the test procedure to a mobile device indicating the location of any damage.

### BRIEF DESCRIPTION OF THE DRAWINGS

An embodiment of the invention is now described by way of example only with reference to the accompanying drawings in which:

FIG. 1 shows an acoustic liner panel in situ in a jet engine

FIG. 2 shows the inside perforated skin of the panel of FIG. 1

FIG. 3 shows both side and cross section of the panel of FIG. 1

FIG. 4 exposes a damaged section of the panel of FIG. 1

FIG. 5 is an enlargement of the damaged section of FIG. 4

FIG. 6 shows an instrument passing over the perforated skin of the panel of FIG. 1

FIG. 7 is an enlargement of the instrument in FIG. 6

FIG. 8 is an exploded view of the instrument in FIG. 6 viewed from above

FIG. 9 is an exploded view of the instrument in FIG. 6 viewed from below

FIG. 10 is a cross section of FIG. 8 through the centerline of the instrument

FIG. 11 is a perspective view of FIG. 11

FIG. 12 shows a damaged section of the panel of FIG. 1

FIG. 13 is an enlargement of the damaged section in FIG. 12

FIG. 14 is FIG. 10 showing flow of air particles

FIG. 15 is a perspective view of FIG. 14

FIG. 16 illustrates a graphic user interface for use with the instrument of FIG. 6

### DETAILED DESCRIPTION OF THE INVENTION

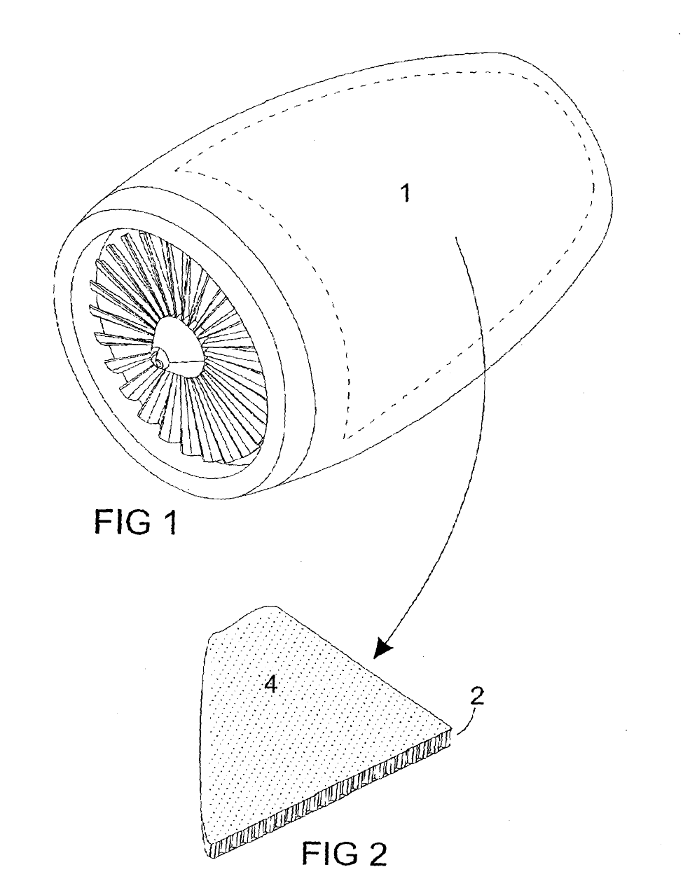

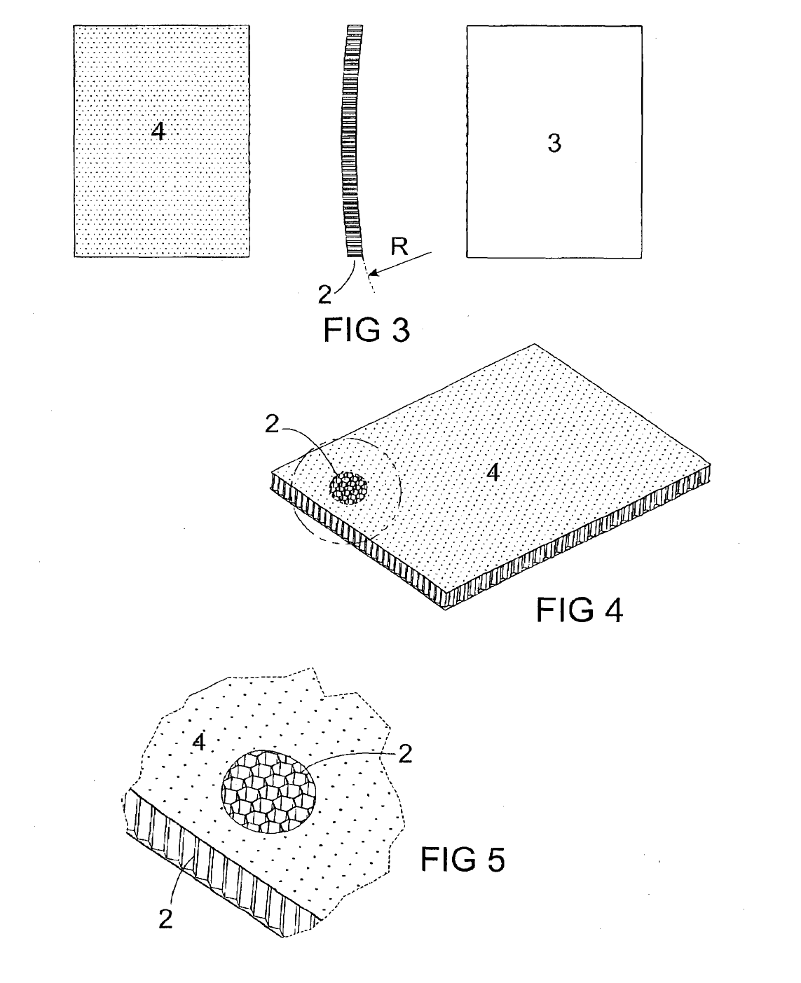

FIGS. 1 to 3 show the location and structure of an acoustic liner used on the engine of a typical commercial jet aircraft. Panel 1 consists of an internal sound absorbing honeycomb structure 2 with external whole skin 3 and perforated skin 4. FIGS. 4 and 5 reveal honeycomb structure 2 in detail.

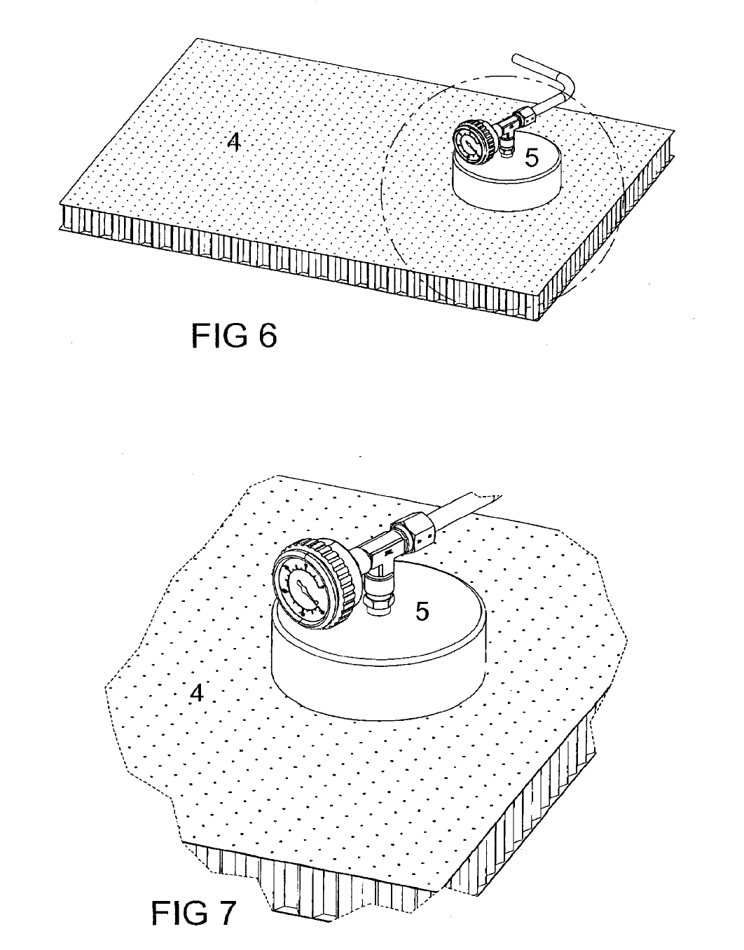

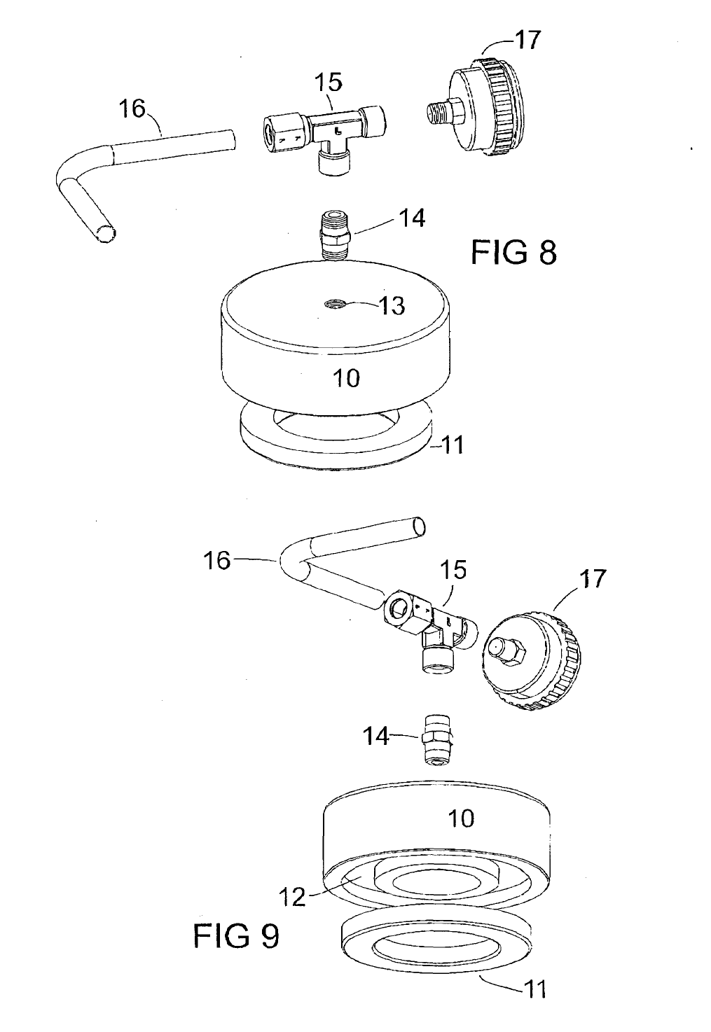

In FIGS. 6 and 7 instrument 5 is shown sliding over skin 4 during testing, Instrument 5 consists of cup shaped body 10 with resilient sealing annulus 11 set into recess 12 of the open end of body 10 and protruding beyond it, as shown in FIGS. 8 and 9. The closed end of body 10 has central threaded hole 13 to receive connector 14 on which is mounted T junction 15. One side of junction 15 connects to vacuum line 16 and the other to pressure gauge 17.

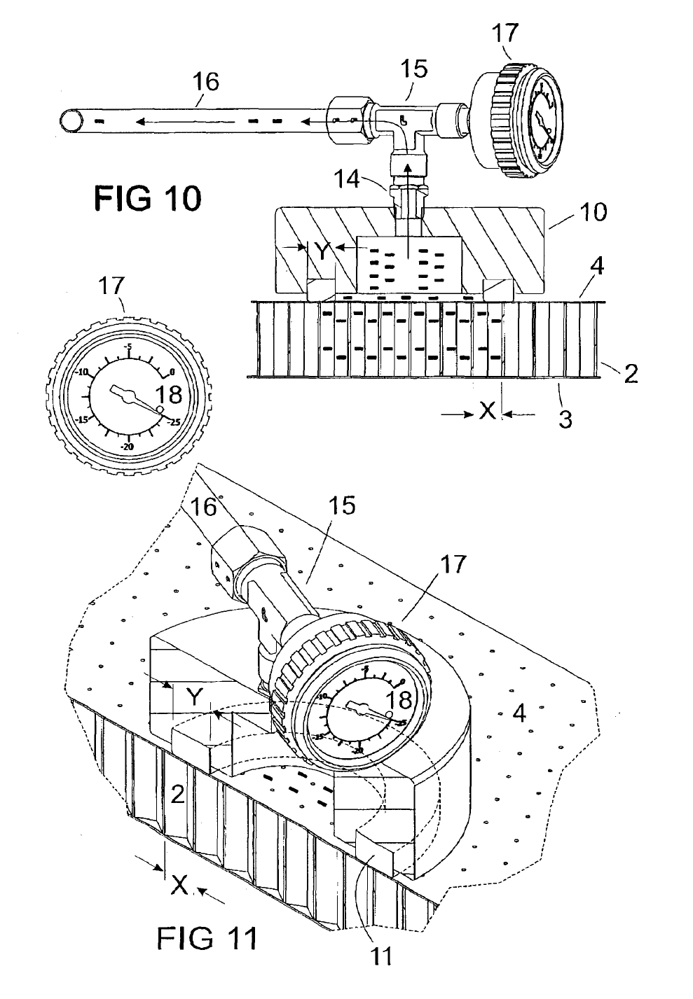

Instrument 5 is shown operating in FIGS. 10 and 11 where air is drawn from body 10 through line 16 creating a vacuum which is measured on dial 18 of gauge 17. When honeycomb structure 2 and skin 3 are sound the vacuum in body 10 is maintained as shown by the constant negative reading on dial 18 of pressure gauge 17.

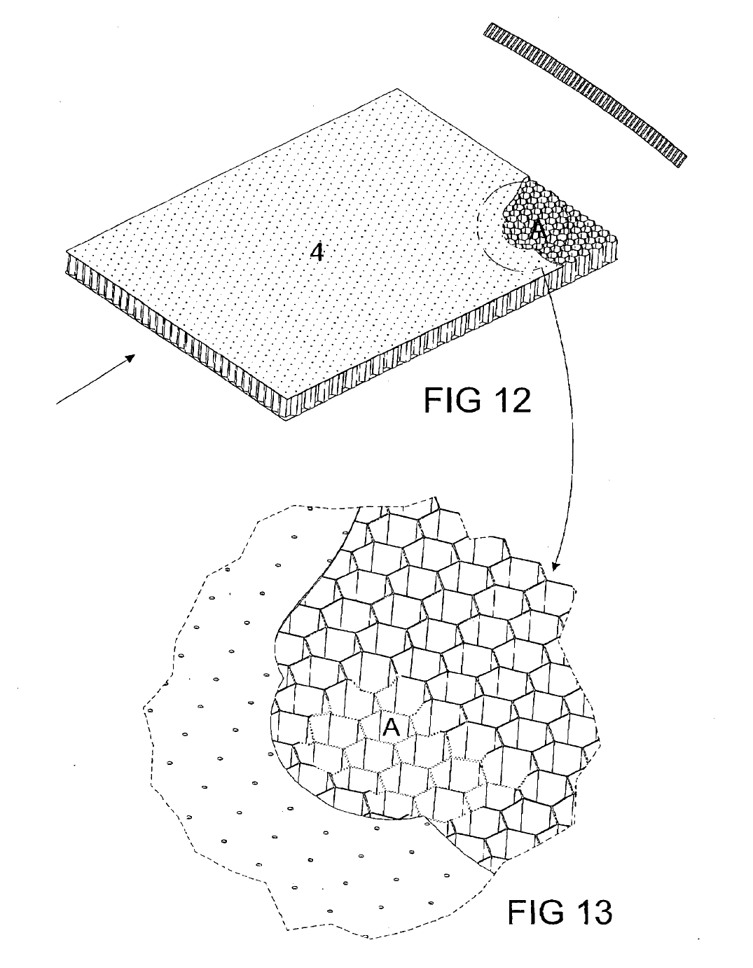

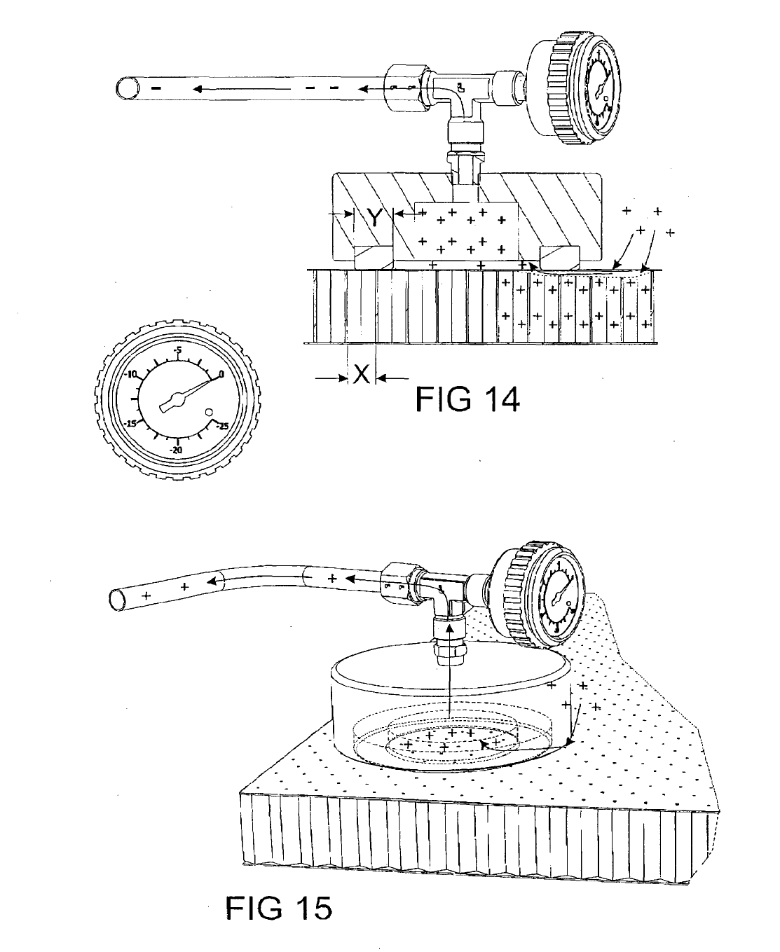

However when instrument 5 encounters damaged structure 2 in region A as shown in FIGS. 12 and 13 air is sucked into body 10 through damaged structure 2 and dial 18 of pressure gauge 17 registers a loss of vacuum as shown in FIGS. 14 and 15. It will be noted that the width of annulus 11 is more than one width and less than two widths of a cell of honeycomb structure 2 for air to flow in through a damaged cell from surrounding cells.

It will be noted that instrument 5 can also be used to detect damage in so called “double degree of freedom” sandwich structures. The latter have a perforated skin bonded onto a honeycomb layer which is bonded onto a septem. The latter is bonded onto a second honeycomb layer on which is bonded a whole skin. Instrument 5 detects damage in the internal layers in the same manner except that a higher volume airflow is desirable to provide the vacuum pressure. In fact any structures which admit air to their inner layers are amenable to testing with instrument 5.

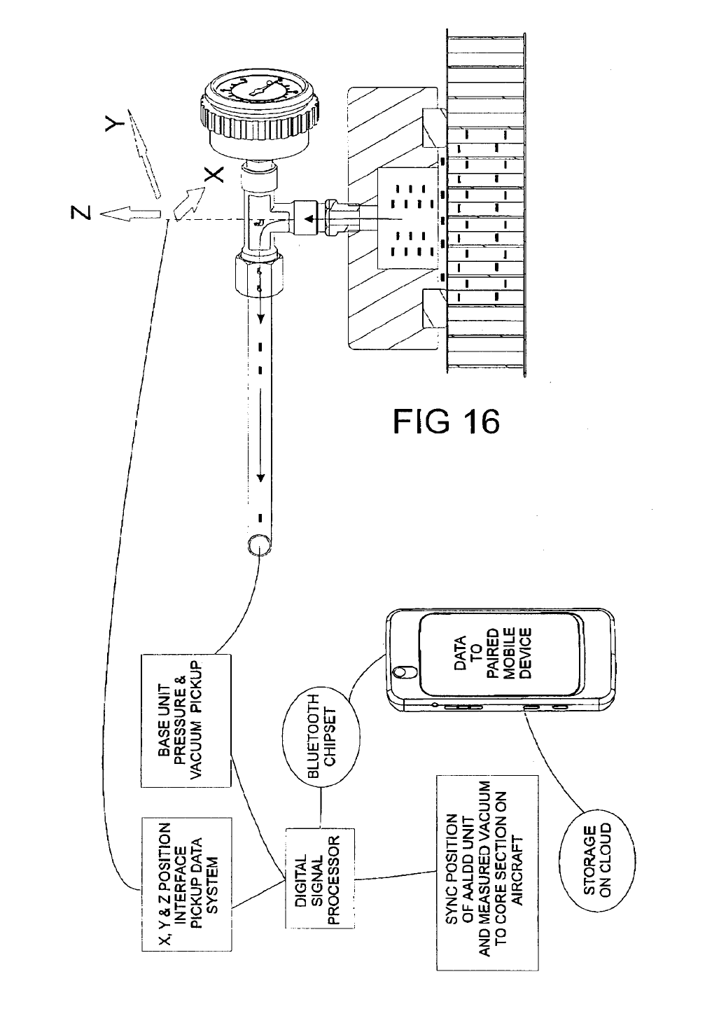

For ease of reading and recording results of a test, instrument 5 may be linked to a processor and graphic user interface as illustrated in FIG. 16. Pressure and corresponding XYZ position pickups from instrument 5 feed data to a processor which transmits a graphic record of the test procedure to a mobile device indicating the location of any damaged sections.

### VARIATIONS

It will be realized that the foregoing has been given by way of illustrative example only and that all other modifications and variations as would be apparent to persons skilled in the art are deemed to fall within the broad scope and ambit of the invention as herein set forth. Throughout the description and claims of this specification the words “comprise” and variations of that word such as “comprises” and “comprising” are not intended to exclude other additives components integers or steps.

1. A damage detector for an acoustic liner sandwich of an internal cellular structure between a whole skin and a perforated skin comprising a cup shaped body the open end of which maintains sealing engagement with the perforated skin of the liner and a vacuum line connected to the body and a pressure gauge so that a loss of vacuum registered on the gauge indicates damage to the internal structure.

2. The detector of claim 1 in which sealing engagement is achieved by locating a flexible annulus in a mating recess in the open end of the cup shaped body.

3. The detector of claim 2 in which the width of the annulus is between one and two maximum widths of the cells of the internal structure.

4. The detector of claim 1 in which the vacuum line and the pressure gauge are connected at opposite sides of a T junction connector mounted on the body.

5. The detector of claim 1 which is linked to a processor and graphic user interface.

6. The detector of claim 5 in which pressure and XYZ position pickups from the detector feed data to a processor which transmits a graphic record of the test procedure to a mobile device indicating the location of any damage.
